(19) United States
(12) Patent Application Publication
(10) Pub. No.: US 2016/0124070 A1
(43) Pub. Date: May 5, 2016

(54) METHODS AND APPARATUS FOR DETECTING GNSS SATELLITE SIGNALS IN SIGNAL DEGRADED ENVIRONMENTS

(71) Applicant: RX NETWORKS INC., Vancover (CA)

(72) Inventors: Muhammad Haris AFZAL, Vancouver (CA); Behnam AMINIAN, Vancouver (CA)

(21) Appl. No.: 14/896,354

(22) PCT Filed: Jun. 5, 2013
(86) PCT No.: PCT/CA2013/050431

§ 371 Date: Dec. 4, 2015

(51) Int. Cl. G01S 5/02; G01S 19/24; G01S 19/42; G01S 19/10

(52) U.S. Cl. CPC G01S 5/0263; G01S 19/10; G01S 19/24; G01S 19/42

(57) ABSTRACT

A location determining device and method of detecting GNSS signals, the method includes: determining candidate GNSS satellites orbiting above the location determining device using an estimated location area, time and predicted orbit data of all GNSS satellites and for the candidate GNSS satellites, determining nominal Dopplers by projecting velocities of the candidate GNSS satellites onto the estimated location area; determining correlation search spaces around the respective nominal Dopplers over estimated code phases; determining correlators for the correlation search spaces and performing correlation; determining receiver clock bias when correlation peaks associated with a majority of GNSS satellites are located at a common Doppler offset; detecting GNSS signals within the common Doppler offset using a set of detectors, one of the set of detectors detecting a correlation peak having a highest probability of detection; and determining a reduced search space in which GNSS signals may be detected.

### TECHNICAL FIELD

The present application relates to methods and apparatus for detecting Global Navigation Satellite System (GNSS) satellite signals using short intermediate frequency data captures.

### BACKGROUND DISCUSSION

In conditions in which communication between a Global Navigation Satellite System (GNSS) receiver and overhead GNSS satellites is available, information from at least four GNSS satellites is used by the GNSS receiver in order to determine its three dimensional position. Signal degradation or unavailability of satellites due to challenging environments such as indoors, in densely forested areas or in deep urban locations, for example, where attenuation and multipath effects make it difficult for the GNSS receiver to discriminate and acquire information from the required number of GNSS satellites.

In order to estimate a GNSS receiver's position, assistance from other sources that use technologies such as Wi-Fi and Cellular-based positioning, for example, may be used to provide coarse position assistance. Cooperation between a GNSS receiver and any other positioning technology and/or GNSS information server is referred to as Assisted-GNSS (A-GNSS).

A well-known GNSS is the Global Positioning System (GPS). In Assisted-GPS (A-GPS) where initial position, initial time and satellite ephemeris assistance is available, the receiver is able to focus on acquiring those satellites that are passing overhead. This process is often referred to as sky search and helps to reduce the signal processing complexities of a receiver during satellite acquisition. Because GNSS satellites revolve around the Earth at orbital speeds that are higher than the Earth's rotation, the signals received from GNSS satellites in the vicinity of Earth encounter changes in their frequencies, which is known as satellite Doppler. In addition to the satellite Doppler, a GNSS receiver's local clock bias as well as the GNSS receiver's motion cause the receiver to receive satellite signals at frequencies that are different from the transmission frequency of the GNSS satellite. Because of these frequency differences, satellite signal detection is a complex process that requires extensive signal processing power at the receiver. Signal degradations due to environmental and interference effects add to the complexity and may cause the receiver to fail to acquire satellites.

### SUMMARY

In general, the methods and apparatus of the present application facilitate determination of a location relatively quickly using strong satellite signals to assist in detecting weaker satellite signals by using a common Doppler frequency offset of three or more GNSS satellites signals to reduce a correlation search space. In an embodiment, information is shared between location determining devices to facilitate determination of a reduced correlation search space.

In an aspect of the present disclosure there is provided, a method of detecting GNSS signals, including: receiving, at a processor of a location determining device, digitized data representing the GNSS signals, the digitized data being stored in a memory of the location determining device in association with a time at which the GNSS signals were received; receiving, at the processor of the location determining device, an estimated location area from a non-GNSS positioning application; determining, at the processor, candidate GNSS satellites orbiting above the location determining device using the estimated location area, the time and predicted orbit data of all GNSS satellites; for the candidate GNSS satellites, determining nominal Dopplers by projecting velocities of the candidate GNSS satellites onto the estimated location area; determining correlation search spaces around the respective nominal Dopplers over estimated code phases; determining correlators for the correlation search spaces and performing correlation; determining receiver clock bias when correlation peaks associated with a majority of GNSS satellites are located at a common Doppler offset; detecting GNSS signals within the common Doppler offset using a set of detectors, one of the set of detectors detecting a correlation peak having a highest probability of detection; determining a reduced search space within the common Doppler offset corresponding to a code phase of the one of the set of detectors; wherein the location determining device is located within the estimated location area.

In another aspect of the present disclosure, there is provided a location determining device including: a memory for communicating with an RF front end, the memory storing digitized data representing GNSS satellite signals, the digitized data received at the location determining device stored in association with a time at which the GNSS satellite signals were received; a processor in communication with the memory, the processor configured to receive an estimated location area in which the location determining device is located, determine candidate GNSS satellites orbiting above the location determining device using the estimated location area, the time and predicted orbit data of all GNSS satellites and, for the candidate GNSS satellites: determine nominal Dopplers by projecting velocities of the candidate GNSS satellites onto the estimated location area; determine correlation search spaces around the respective nominal Dopplers over estimated code phases; determine correlators for the correlation search spaces and performing correlation; determine receiver clock bias when correlation peaks associated with a majority of GNSS satellites are located at a common Doppler offset; detect GNSS signals within the common Doppler offset using a set of detectors, one of the set of detectors detecting a correlation peak having a highest probability of detection; and determine a reduced search space within the common Doppler offset corresponding to a code phase of the one of the set of detectors.

In another aspect of the present disclosure there is provided a method of determining a location including: receiving, at a second location determining device, a reduced search space, the reduced search space comprising a frequency range and a code phase range, the reduced search space having been determined by a first location determining device; determining a search space by increasing one of: the frequency range, the code phase and the frequency range and the code phase range of the reduced search space to account for uncertainty; detecting GNSS signals within the search space; and when GNSS signals from three satellites are detected, determining the location the second location determining device.

When determining a three dimensional location using Global Navigation Satellite System (GNSS) satellites in which Intermediate Frequency (IF) data captures spanning less than six seconds are received, information from at least five GNSS satellites may be used to determine the location.

Other aspects and features of the present embodiments will become apparent to those ordinarily skilled in the art upon review of the following description of specific embodiments in conjunction with the accompanying figures.

### BRIEF DESCRIPTION OF THE DRAWINGS

Embodiments of the present application will now be described, by way of example only, with reference to the attached Figures, in which:

FIG. 1 is a schematic diagram of a location determining device in communication with GNSS satellites and other signal generation sources;

FIG. 2A is a simplified block diagram of components of the location determining device of FIG. 1 according to an embodiment;

FIG. 2B is a simplified block diagram of components of the location determining device of FIG. 1 according to another embodiment;

FIG. 3 is a simplified block diagram of a Radio Frequency (RF) Front End;

FIG. 4 is a flow diagram depicting a method of determining a location;

FIG. 5 is a flow diagram depicting a sky search method;

FIG. 6 is a schematic diagram showing an example correlation search space of the sky search method;

FIG. 7 is a flow diagram depicting a signal acquisition method;

FIG. 8 is a schematic diagram explaining estimation of clock bias using correlation information from multiple satellites;

FIG. 9 is a schematic diagram showing interference mitigation;

FIG. 10 is a graph depicting prior art detection techniques of GNSS receivers;

FIG. 11 is a graph depicting detection using the methods of FIGS. 4, 5 and 7 to detect signals at different detection thresholds;

FIG. 12 depicts different detectors associated with different sensitivities and probabilities;

FIG. 13 is a flow diagram depicting a method of determining a location by another location determining device; and

FIG. 14 a schematic diagram showing examples of a reduced search space, modified search space and a correlation search space.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will be appreciated by a person skilled in the art that the methods and apparatus of the present application are applicable to any GNSS including Global Positioning System (GPS), GLONASS, Galileo, BeiDou and Iridium, for example.

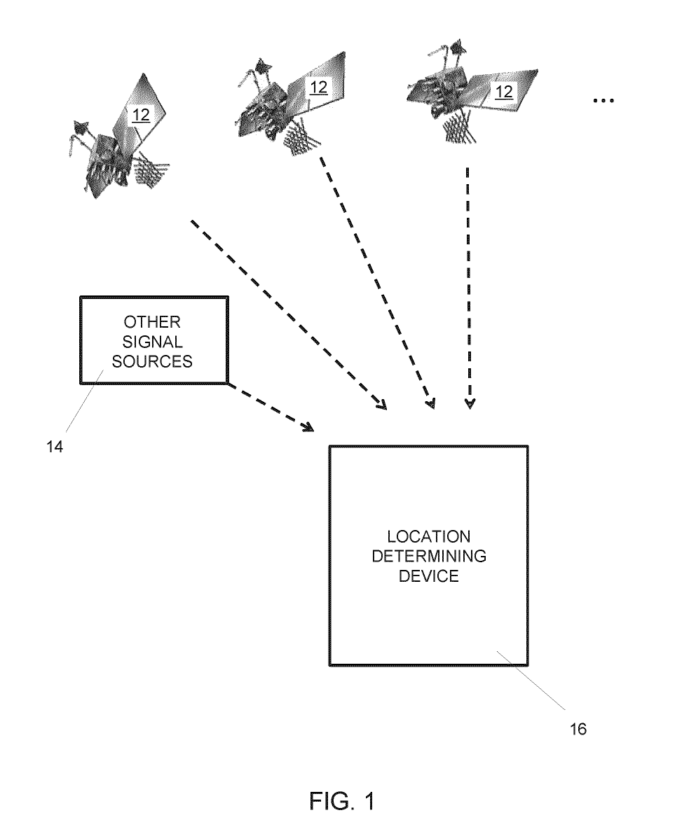

Referring to FIG. 1, a location determining device 16, which may also be referred to as a hybrid positioning device, receives signals from GNSS satellites 12 and may optionally receive signals from other signal sources 14 in order to determine its position. The location determining device 16 may be provided in a cell phone, a personal digital assistant, a Smartphone, an asset tracking device, a tablet or laptop computer, a navigation device or another device seeking its location. In some embodiments, the location determining device 16 is a device that is intended to be stationary, such as a Wi-Fi Access Point (AP), femtocell or office equipment such as a photocopier, for example. When the location determining device 16 is an asset tracking device, many devices 16 may be used as part of a fleet monitoring system, for example.

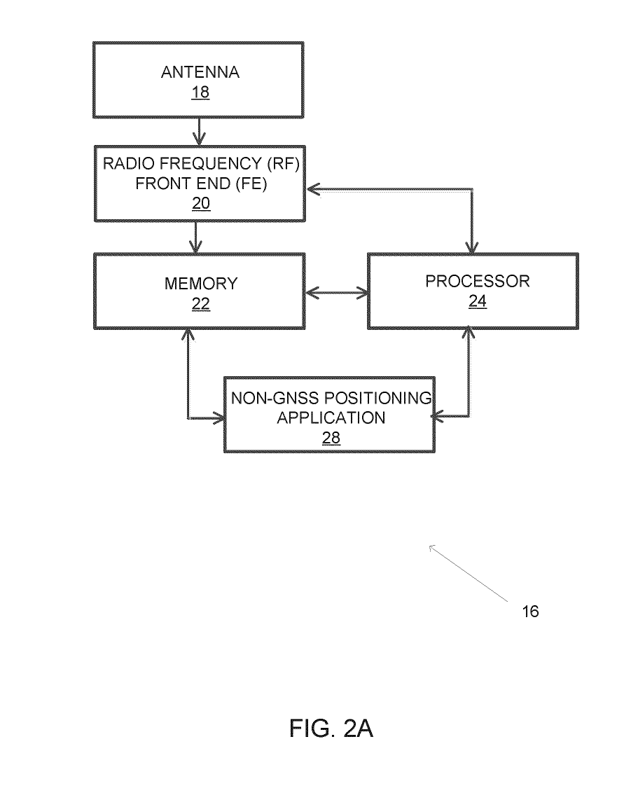

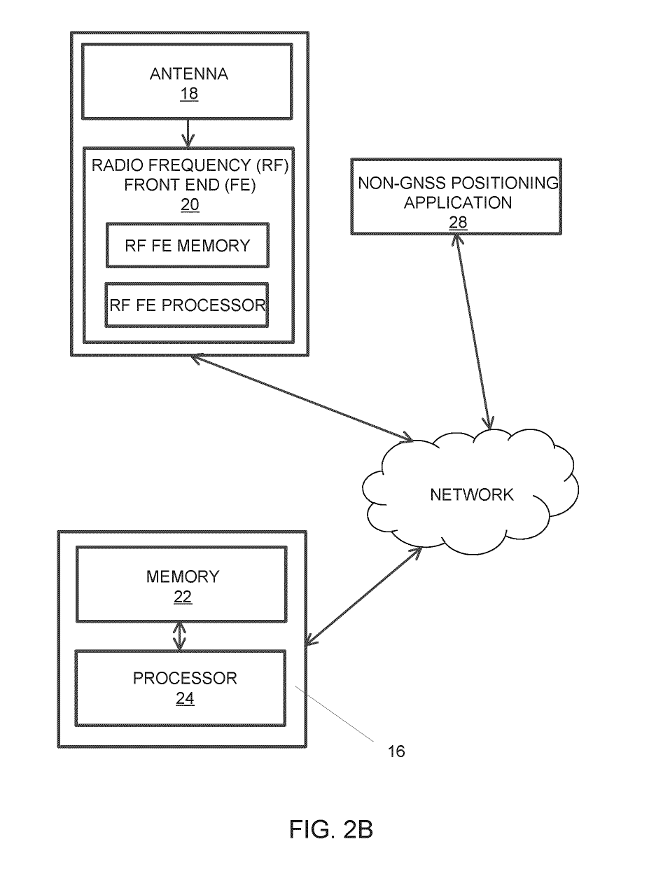

As shown in FIG. 2a, the location determining device 16 includes an antenna 18 for receiving signals including GNSS signals, a Radio Frequency (RF) Front End (FE) 20 in communication with the antenna 18 and a memory 22 that receives digitized GNSS signals from RF FE 20. The memory 22 further communicates with a processor 24. A non-GNSS positioning application 28 is stored as computer readable code in the memory 22 and is executable by the processor 24 to facilitate determination of an estimated location area by the processor 24. In the embodiments described herein, assisted position information derived from the non-GNSS positioning application includes at least initial, or coarse, position assistance, which is used by location determining device 16 to locate GNSS satellites passing overhead and to determine a correlation search space. The non-GNSS positioning application 28 may be any positioning application capable of providing a coarse position estimate. In an embodiment, information from a network interface of the location determining device 16 may be used to provide a coarse position estimate.

Examples of non-GNSS positioning applications include: WiFi-based positioning, cellular-based positioning (including but not limited to mobile standards such as GSM, CDMA, UMTS, LTE), landmobile radio systems (including but not limited to VHF systems used in private or public safety applications), radio-broadcast positioning (including, but not limited position based on radio broadcast transmission towers such as FM or TV stations), other data network infrastructure based positioning (including but not limited to IP routers, data modems or Internet protocols such as GeolP), NFC (near field communication), or other positioning methods based on MEMS inertial sensors such as INS (inertial navigation system) and PDR (pedestrian dead reckoning).

In an embodiment in which the non-GNSS positioning application 28 uses WiFi-based positioning or another radio signal-based technology, the location determining device 16 includes another signal processor, which includes a second antenna and associated hardware for receiving and processing RF signals other than GNSS signals, and the memory 22 receives digitized signals from the other signal processor. The other signal processor may be located separately from the location determining device 16 and in communication therewith. In this embodiment, the other signal processor may not include the second antenna and the antenna 18 may be a large bandwidth antenna so that both the RF FE 20 and the other signal processor may receive signals therefrom. In this embodiment, additional noise due to the large bandwidth may be compensated for.

In an embodiment, the non-GNSS positioning application 28 may be omitted from the location determining device 16 and the location determining device 16 may instead communicate with a computer to receive an estimated location area from a non-GNSS positioning application via a cellular data network, such as GPRS, EDGE, 3G, 4G, WLAN, 802.11g, or 802.11n, for example. The location determining device 16 may further be capable of short range communication using Bluetooth™, NFC and may also be equipped with MEMS sensors, for example.

Referring to FIG. 2B, in addition to a centralized architecture, which is shown in FIG. 2A, the location determining device 16 may alternatively be implemented using a distributed architecture. As shown in FIG. 2B, the antenna 18 and RF FE 20 and non-GNSS positioning application 28 may be located remotely from the location determining device 16 and communicate therewith via the Internet or another network, for example. The antenna 18 and RF FE 20 may be co-located with the non-GNSS positioning application 28 or may be separate.

In an embodiment, the location determining device 16 is provided at a server that is remote from a location requesting device, which includes the antenna 18 and RF FE 20. In this embodiment, the location requesting device may be a cell phone, a personal digital assistant, a Smartphone, an asset tracking device, a tablet or laptop computer, a navigation device or another device seeking its location. In some embodiments, the location determining device 16 is a device that is intended to be stationary, such as a Wi-Fi Access Point (AP), femtocell or office equipment such as a photocopier, for example.

In an embodiment, the processor 24 of the location determining device 16 receives digitized data from more than one RF front end. The RF front ends receive GNSS signals from their antennae and digitize the GNSS signals as has been described above.

Although components such as the memory 22 and the processor 24 of the location determining device 16 have been described as individual components, the method may be implemented using multiple memory components and multiple processor components.

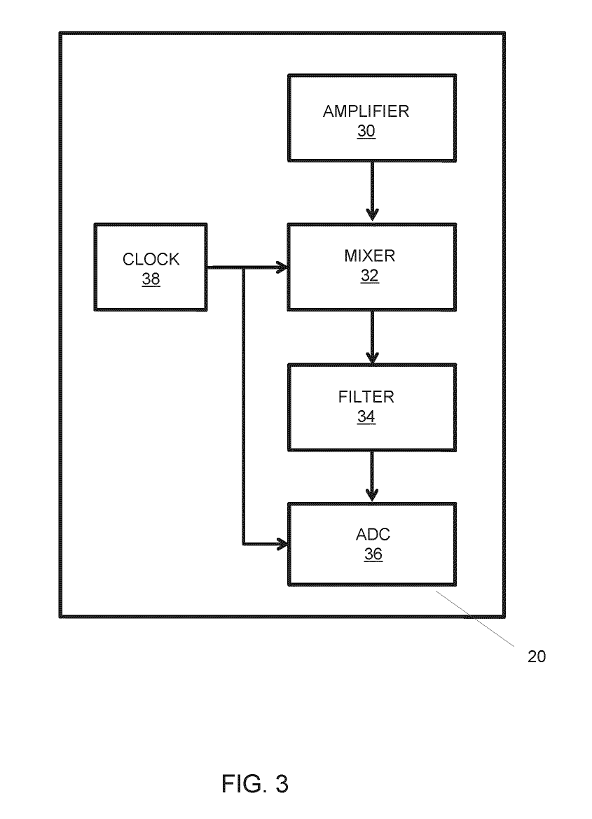

Referring to FIG. 3, the RF FE 20 receives analog signals from antenna 18, amplifies the signals using an amplifier 30, mixes the signals with a lower frequency, which is also known as down conversion using mixer 32 and filter 34, and digitizes the down converted signals using an Analog to Digital Converter (ADC) 36 in order to determine Intermediate Frequency (IF) data. The digitized GNSS signals are stored in the memory 22. The mixer 32 and ADC 36 of the RF FE 20 are synchronized by a clock 38, which is also referred to as a receiver clock. The clock 38 of the RF FE 20 is of lower quality than clocks of the GNSS satellites.

In the present application, the GNSS receiver is incorporated into the location determining device 16. Referring back to FIG. 2A, GNSS receiver components include antenna 18, RF FE 20, memory 22 and processor 24. Because the location determining device 16 incorporates a GNSS receiver and also performs location determination using the non-GNSS positioning application 28, the location determining device 16 is able to provide a hybrid positioning solution.

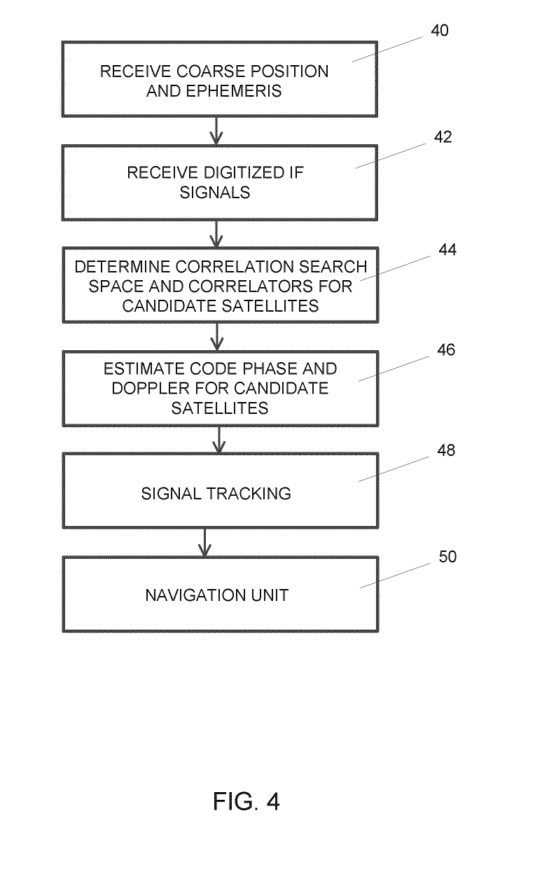

Referring to FIG. 4, a method of determining a location is generally shown. The method may be used when short intermediate frequency (IF) data captures are received at the location determining device 16, such as data captures spanning less than six seconds, for example. IF data is typically between 0 Hz and 100 MHz, for example, however, may also be higher. The method includes: receiving, at the processor 24, a coarse position and ephemeris data for all available satellites at 40; receiving, at the processor 24, digitized IF signals from the memory 22 at 42; determining, at the processor 24, a correlation search space and correlators for candidate satellites at 44; estimating, at the processor 24, code phase and Doppler for candidate satellites at 46; performing signal tracking, at the processor 24, by fine tuning the code phase and Doppler estimates after the satellites have been acquired at 48; and performing navigation, at the processor 24, by using the code phase and Doppler estimates and estimating the location determining device's location, at 50. As will be understood by a person skilled in the art, signal tracking and estimation of the location are achieved using known methods and therefore will not be described further here.

According to the method of FIG. 4, the non-GNSS positioning application 28 computes a coarse position using one of the methods described above and sends the coarse position to the processor 24. The processor 24 also receives information relating to GNSS satellite orbits for all available satellites in the form of ephemeris data, for example. The ephemeris data may be in broadcast or predicted form. The ephemeris data may be received from a server remote from the location determining device 16 or may be generated on the location determining device 16.

The method of FIG. 4 may be performed by the processor 24 by executing one or more software applications that are stored in memory 22 as computer readable code. Alternatively, the method may be performed by dedicated hardware of the processor 24 or in communication with the processor 24, such as Application Specific Integrated Circuit (ASIC) or Graphics Processing unit (GPU), for example, or by a combination of hardware and software.

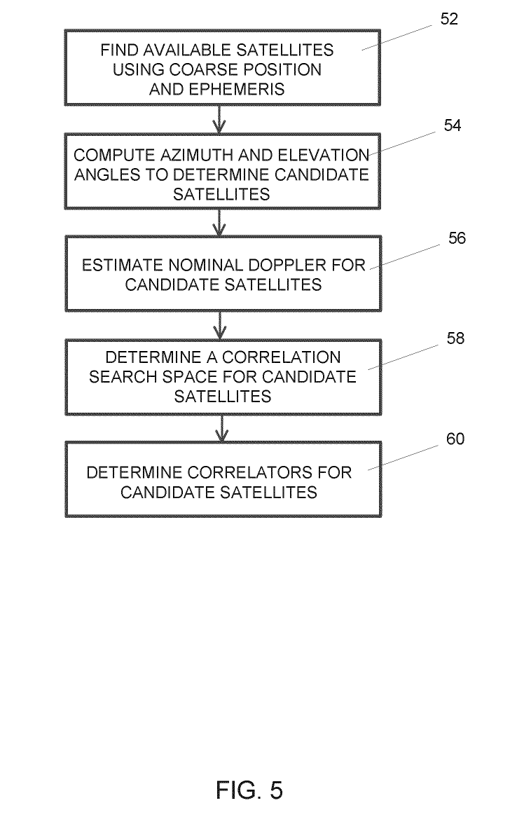

The correlation search space and correlators for candidate satellites of the method of FIG. 4 are determined using a sky search application. Referring to FIG. 5, a method of operation of the sky search application is shown. At 52, the sky search application identifies all available satellites. The satellites are located using the coarse position, current time and ephemeris information. Because the satellite ephemeris data contains details about satellite orbits, the sky search application is able to find the location of satellites in space relative to the coarse position. At 54, the sky search application computes azimuth and elevation angles for the satellites with respect to the coarse position and current time. Satellites that are below the horizon of the current coarse position are rejected and the remaining satellites are determined to be candidate satellites. This allows for the location determining device 16 to concentrate its processing resources on the satellites that are detectable overhead at the current location and time. At 56, the sky search application uses the azimuth and elevation angles to project satellites' velocity onto the coarse position and estimate the effect of satellite to user dynamics on signal frequency, known as nominal Doppler. A correlation search space is then determined using the nominal Doppler for all of the candidate satellites at 58.

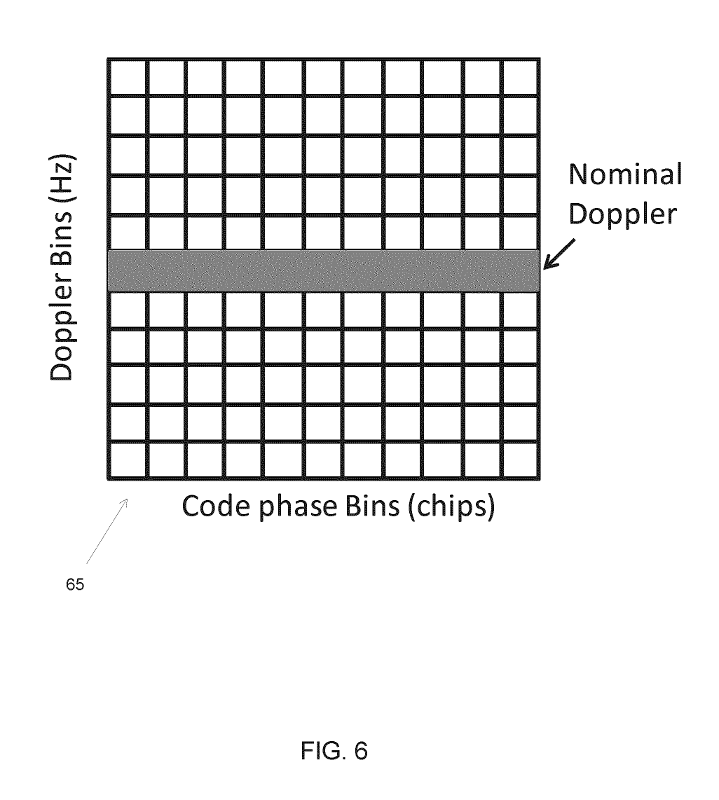

Referring to FIG. 6, an example correlation search space 65 of the sky search application is depicted in the form of a two dimensional grid of correlators. One of the dimensions, which is shown as vertical in FIG. 6, includes information regarding the Doppler or the frequency shift of satellite signals. The nominal Doppler is at the centre of this dimension and the upper and lower bounds in frequency domain are based on the clock uncertainty and user dynamics uncertainty. The second dimension, which is shown as horizontal in FIG. 6, of the correlation search space includes information relating to the code phase, which is also referred to as the time delay, experienced by RF signals while travelling from the satellite to the location determining device 16. The time delay, when estimated, is used for estimation of the expected range between satellite and user, which is commonly known as a pseudorange, as described with reference to the navigation step of FIG. 4. The upper and lower bounds in code phase domain depend on the type of GNSS satellite signal as well as the sampling frequency of RF FE 20 or the correlation resolution.

In an embodiment, large uncertainties that cover all possible clock uncertainty and user dynamics uncertainty may be used for determination of the correlation search space. In another embodiment, when information relating to clock uncertainty and user dynamics uncertainty is available, such information may be used to reduce the correlation search space. Clock uncertainty information can be either obtained from the specification sheet of the RF FE clock 38 or by analytic means that include detailed error modeling, which may be achieved using Power Spectral Density (PSD) analysis or Allan variance analysis, as would be understood by a person skilled in the art. User dynamics uncertainty is based on the application of the location determining device 16. For example, when the location determining device 16 is a static device, the contribution to the determination of the correlation search space due to user dynamics is zero. As will be appreciated by a person skilled in the art, performance of the sky search application is not affected by changes in the definition of correlation search space.

Referring back to FIG. 5, at 60, the sky search application determines correlators for the correlation search space. Any type of correlators may be used such as: time domain convolution based correlators, frequency domain Fourier transform based correlators, and frequency domain circular correlation based correlators, for example. All of the correlators in the correlation search space may be the same or, alternatively, different correlators may be used within the same correlation search space.

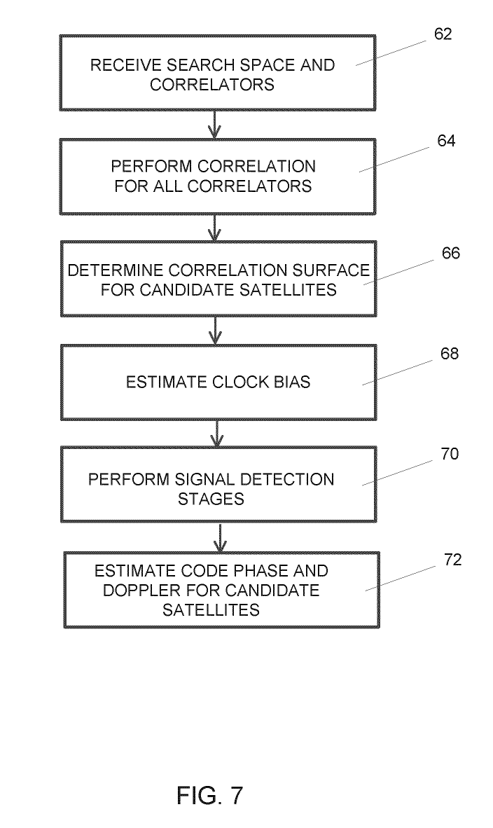

Referring now to FIG. 7, operation of the signal acquisition application corresponding to step 46 of FIG. 4 is shown. In general, the signal acquisition application uses the digitized RF signals received from the RF FE 20 (via the memory 22) and the correlation search space in order to find GNSS satellite signals in the digitized data. At 62, the correlation search space and correlators for the candidate satellites are received from the sky search application. The signal acquisition application then performs correlation operations for all of the correlators in search spaces of all candidate satellites at 64. Batch processing is performed for the correlation operation in order to obtain a correlation surface for each candidate satellite, at 66. An example correlation surface is shown in FIG. 6 in which each box of the grid corresponds to a correlator. Then, at 68, a clock bias associated with the RF FE clock 38 is estimated using all of the correlation surfaces.

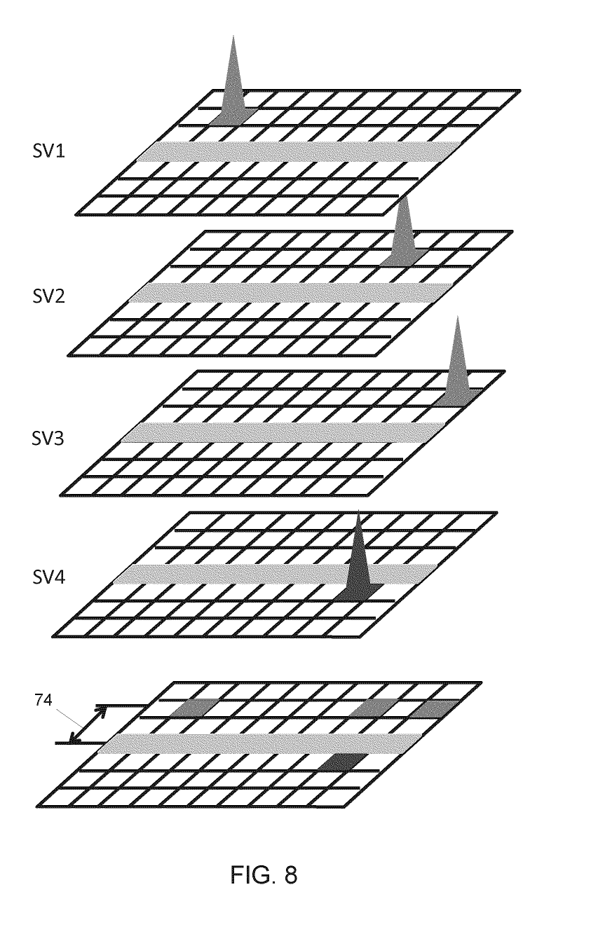

Estimation of the clock bias will be described with reference to FIG. 8 in which correlation surfaces for four candidate satellites, SV1, SV2, SV3 and SV4, are shown. Each correlation surface includes the nominal Doppler bin for the corresponding candidate satellite identified in the middle. After the correlation operation is performed on all candidate satellites for all correlators in batch processing mode, correlation peaks for the satellites are identified at different locations in the search spaces. When three or more and the majority of the correlation peaks are at a common frequency offset from the nominal Doppler bin, the Doppler bin at that frequency offset is determined to be a common Doppler bin. The Doppler offset 74 between the nominal Doppler bin and the common Doppler bin is determined to be the estimated clock bias for the clock 38. Correlation peaks located at offsets that are different from the majority of the correlation peaks are false correlation peaks that may result from interference and very weak signals. These false correlation peaks are excluded from the search, thereby improving the execution time of the signal acquisition application.

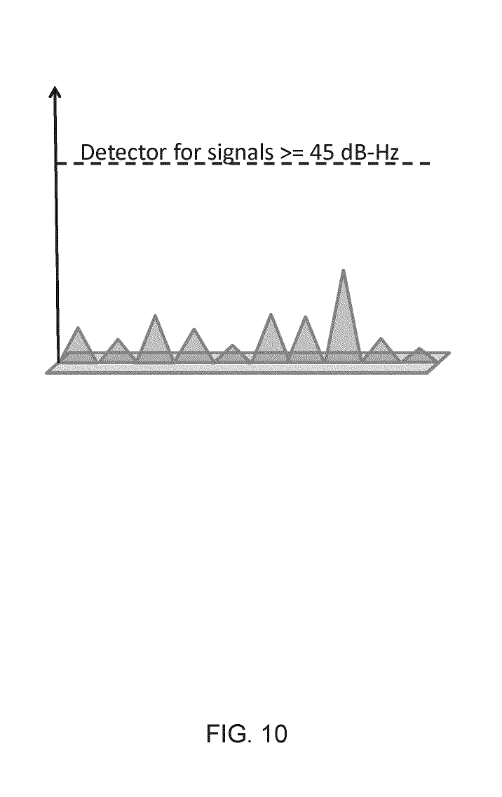

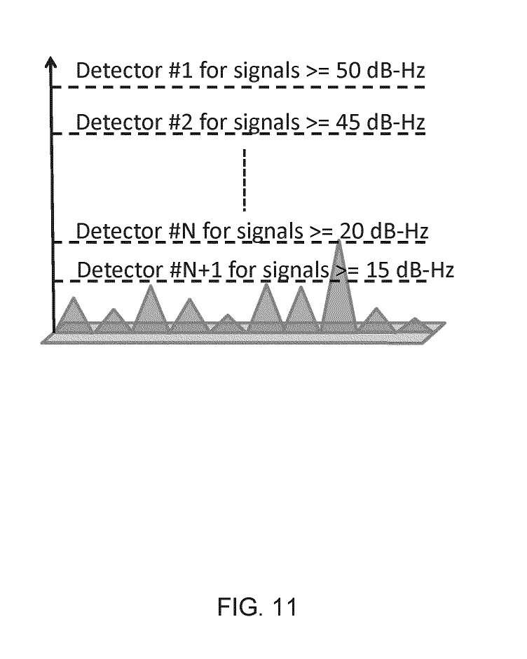

At 70, signal detection stages are performed in which each stage corresponds to a different Carrier to Noise ratio (C/N0). Signal detection within the common Doppler bin will now be described with reference to FIGS. 10, 11 and 12. Referring to FIGS. 10 and 11, correlation results from the common Doppler bin are shown. In FIG. 10, one detector that is capable of detecting signals greater than or equal to 45 dB-Hz is used. As shown, signals present but below the C/N0 threshold of the detector, are missed, resulting in the reduction of the probability of detection. In the methods described herein, a set of detectors are used to perform an exhaustive search for the presence of signals, as shown in FIG. 11. The set of detectors constitutes detection slices and this method of signal detection may be referred to as hyper-slicing.

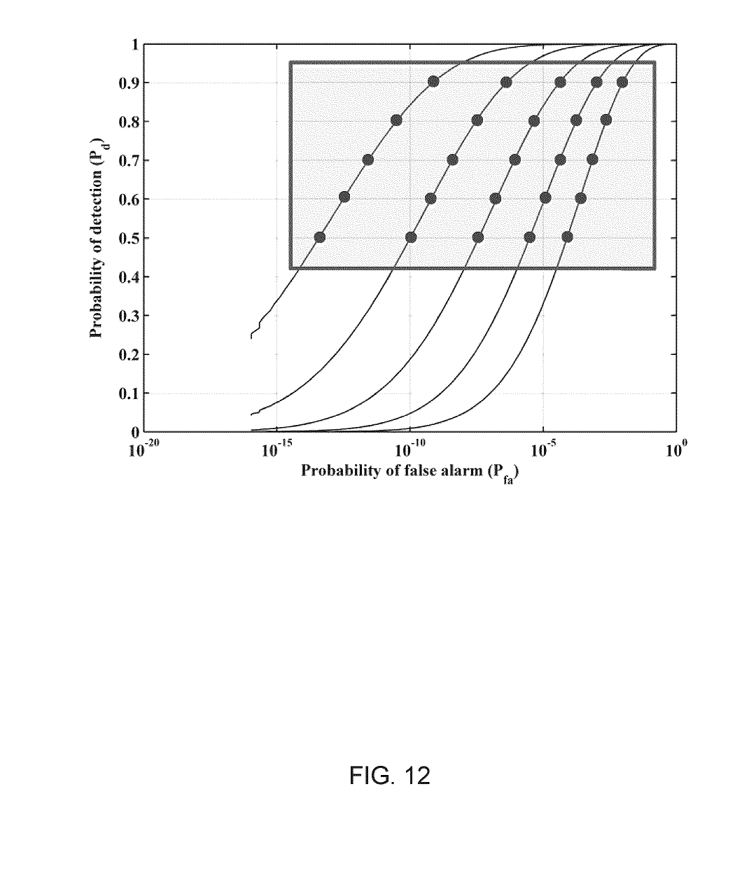

Referring to FIG. 12, different Receiver Operating Characteristics (ROC) curves are obtained for different data capture sizes and signal strengths. The method of producing ROC curves is well documented in literature relating to statistical detection theory and the methodology is used herein for determining hyper-slices. The ROC curves are used as models for obtaining the detection thresholds for different probabilities of detections and false alarms. When a correlation surface is obtained after correlation, an exhaustive search for the presence of GNSS signals is performed by using the hyper-slicing method. The detector satisfied by the correlation peak with the highest probability of detection and lowest probability of false alarm is chosen as the selected detector.

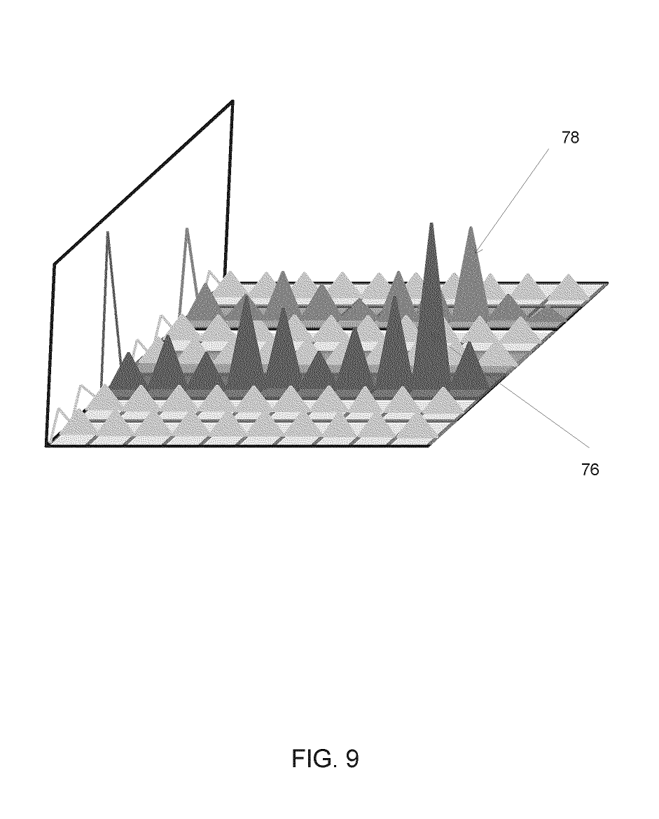

Referring back to FIG. 7, when the selected detector has been determined, estimates of signal strength available from the selected detector are used when determining a reduced search space, at 72. The reduced search space corresponds to the code phase of the common Doppler bin in which the correlation peak with the highest probability of detection is located is determined for the candidate satellites at 72. Referring to FIG. 9, SV4 of FIG. 8 is shown in which the false correlation peak 76 and actual correlation peak 78 are represented as projections in the Doppler domain. Although the highest correlation peak is not located in the common Doppler bin, the methods described herein allow the common Doppler bin to be determined. In general, using the methods described herein, more satellite signals may be detected because the probability of false alarms is reduced thus overall sensitivity of signal detection is increased, as shown in the example of FIG. 9.

The reduced search space may be used to detect satellite signals for a current data capture operation and may also be used to detect satellite signals in subsequent data capture operations from the same location determining device 16. The estimated clock bias is valid for a time period. When the location determining device 16 is static, the time period may be months. When the location determining device 16 is mobile, the time period may be days.

The methods and apparatus described herein efficiently detect GNSS signals to acquire GNSS satellites and determine a location. Correlation is performed a single time for a correlation search space, however, detection everywhere in the search space is achieved. Satellite detection is determined efficiently thus processing time associated with the methods is reduced and power requirements of the location determining device are similarly reduced. Further, by removing false correlation peaks, overall sensitivity of signal detection is increased. For example, the methods described herein may improve detection sensitivity from 25 dB-Hz to 16 dB-Hz for a capture size of 2 seconds.

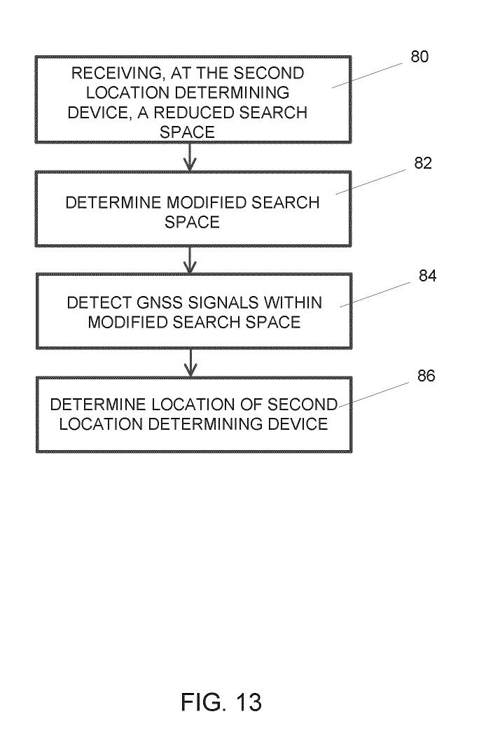

The methods and apparatus described herein may also facilitate determination of a location by a second location determining device, which is in communication with the first location determining device 16. Referring to FIG. 13, a method of determining a location includes: receiving a reduced search space at a processor of the second location determining device, at 80. As previously described, the reduced search space includes a frequency range and a code phase range determined by the first location determining device, as described with respect to step 46 of the method of FIG. 4. After the reduced search space has been received, a modified search space is determined, at 82, by increasing one of: the frequency range, the code phase and the frequency range and the code phase range of the reduced search space. The modified search space is determined to account for one or more of: receiver clock uncertainty, user dynamics uncertainty and location uncertainty of the second location determining device. GNSS signals are then detected within the modified search space, at 84; and when GNSS signals from three satellites are detected, the location the second location determining device is determined, at 86.

In order to determine the size of the modified search space, the level of synchronization between receiver clocks 38 of the location determining devices is determined. The clocks may be synchronized to nano second level by using a timing protocol such as IEEE 1588-2008, for example, or by incorporating configurable oscillators such as Voltage Controlled Temperature Compensated Oscillator (VC-TCXO), for example, to perform clock prediction and offset nullification at the location determining devices. In one example, synchronization to within 10-100 ns is achieved. By synchronizing the receiver clocks 38, sharing of Doppler and code phase information with many different location determining devices is possible.

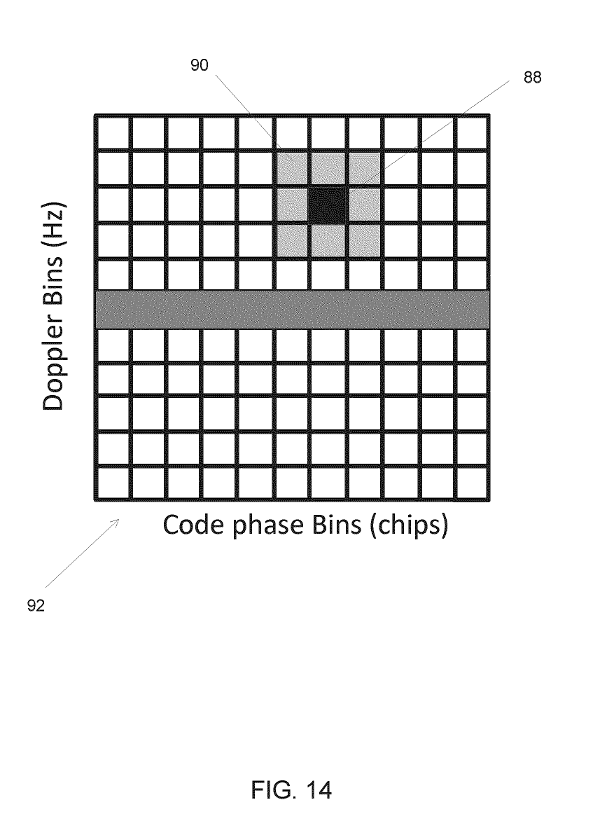

Referring to FIG. 14, a reduced search space 88 and a modified search space 90 are shown in an example correlation search space 92 in the form of a two dimensional grid. A grid representing a correlation search space has been described with respect to FIG. 6 and, therefore, will not be repeated here.

The second location determining device may include similar components as the location determining device 16 and may have similar processing capabilities. Alternatively, the second location determining device 16 may have less processing capabilities. Communication between the first and second location determining devices may occur over a wired connection or wirelessly, for example. Further, the connection between the location determining devices may be direct or may be indirect, such as via a server, for example.

The above-described embodiments are intended to be examples only. Alterations, modifications and variations can be effected to the particular embodiments by those of skill in the art without departing from the scope of the present application, which is defined solely by the claims appended hereto.

1. A method of detecting GNSS signals, comprising:
receiving, at a processor of a location determining device, digitized data representing the GNSS signals, the digitized data being stored in a memory of the location determining device in association with a time at which the GNSS signals were received;
receiving, at the processor of the location determining device, an estimated location area from a non-GNSS positioning application;
determining, at the processor, candidate GNSS satellites orbiting above the location determining device using the estimated location area, the time and predicted orbit data of all GNSS satellites;
for the candidate GNSS satellites,
determining nominal Dopplers by projecting velocities of the candidate GNSS satellites onto the estimated location area;
determining correlation search spaces around the respective nominal Dopplers over estimated code phases;
determining correlators for the correlation search spaces and performing correlation;
determining receiver clock bias when correlation peaks associated with a majority of GNSS satellites are located at a common Doppler offset;
detecting GNSS signals within the common Doppler offset using a set of detectors, one of the set of detectors detecting a correlation peak having a highest probability of detection;
determining a reduced search space within the common Doppler offset corresponding to a code phase of the one of the set of detectors;
wherein the location determining device is located within the estimated location area.

2. The method of claim 1, wherein the GNSS signals are received at an antenna of the location determining device and digitized by an RF front end of the location determining device.

3. The method of claim 1, wherein the GNSS signals are received at an antenna and digitized by an RF front end, the antenna and the Radio Frequency front end being separate from the location determining device and the RF front end being in communication with the location determining device.

4. The method of claim 1, wherein the predicted orbit data is ephemeris data.

5. The method of claim 1, wherein the set of detectors are capable of detecting signals of different signal strength.

6. The method of claim 1, wherein the set of detectors are capable of detecting signals of different probabilities of detection.

7. The method of claim 1, wherein the majority comprises at least three GNSS satellites.

8. The method of claim 1, wherein the non-GNSS positioning application is an application capable of providing an initial position.

9. The method of claim 1, wherein the non-GNSS positioning application is based on one of: W-Fi, Cellular, land-mobile radio, radio broadcast, GeolP, NFC, INS and PDR.

10. The method of claim 1, wherein the correlation search space is determined by estimating clock uncertainties and user dynamics uncertainties.

11. The method of claim 1, wherein the candidate GNSS satellites are determined by computing azimuth and elevation angles for all GNSS satellites and rejecting GNSS satellites located below the horizon of the estimated location area.

12. The method of claim 1, wherein the reduced search space is for sending to a second location determining device.

13. The method of claim 1, comprising detecting GNSS signals of a subsequent data capture within the reduced search space.

14. (canceled)

15. The method of claim 1, wherein the digitized data is received from a first RF front end and a second RF front end, the digitized data representing GNSS signals received by a first antenna in communication with the first RF front end and a second antenna in communication with the second RF front end.

16. A computer readable medium comprising instructions executable on a processor for implementing the method of claim 1.

17. A location determining device comprising:
a memory for communicating with an RF front end, the memory storing digitized data representing GNSS satellite signals, the digitized data received at the location determining device stored in association with a time at which the GNSS satellite signals were received;
a processor in communication with the memory, the processor configured to receive an estimated location area in which the location determining device is located, determine candidate GNSS satellites orbiting above the location determining device using the estimated location area, the time and predicted orbit data of all GNSS satellites and, for the candidate GNSS satellites:
determine nominal Dopplers by projecting velocities of the candidate GNSS satellites onto the estimated location area;
determine correlation search spaces around the respective nominal Dopplers over estimated code phases;
determine correlators for the correlation search spaces and performing correlation;
determine receiver clock bias when correlation peaks associated with a majority of GNSS satellites are located at a common Doppler offset;
detect GNSS signals within the common Doppler offset using a set of detectors, one of the set of detectors detecting a correlation peak having a highest probability of detection; and
determine a reduced search space within the common Doppler offset corresponding to a code phase of the one of the set of detectors.

18. The location determining device of claim 17, comprising an antenna for receiving the GNSS satellite signals and an RF front end in communication with the antenna, the RF front end generating the digitized data representing the GNSS satellite signals.

19. The location determining device of claim 17, wherein the estimated location area is determined by a non-GNSS positioning application stored in the memory and executed by the processor.

20. The location determining device of claim 17, wherein the correlation search space is determined by estimating clock uncertainties and user dynamics uncertainties.

21. The location determining device of claim 17, wherein the candidate GNSS satellites are determined by computing azimuth and elevation angles for all GNSS satellites and rejecting GNSS satellites located below the horizon of the estimated location area.

22. The location determining device of claim 17, wherein the reduced search space is used to detect GNSS satellite signals in subsequent data captures.

23. A method of determining a location comprising:
receiving, at a second location determining device, a reduced search space, the reduced search space comprising a frequency range and a code phase range, the reduced search space having been determined by a first location determining device;
determining a search space by increasing one of: the frequency range, the code phase and the frequency range and the code phase range of the reduced search space to account for uncertainty;
detecting GNSS signals within the search space; and
when GNSS signals from three satellites are detected, determining the location the second location determining device.
